(19) United States
(12) Patent Application Publication
(10) Pub. No.: US 2016/0119975 A1
(43) Pub. Date: Apr. 28, 2016

(54) METHOD AND APPARATUS FOR INTERWORKING WIRELESS LAN ACCORDING TO CAMPING CELL

(71) Applicant: Samsung Electronics Co., Ltd., Gyeonggi-do (KR)

(72) Inventors: Himke Van Der Velde, Zwolle (NL); Jaehyuk Jang, Gyeonggi-do (KR); Soenghun Kim, Gyeonggi-do (KR); Kyeongin Jeong, Gyeonggi-do (KR); Sangbum Kim, Gyeonggi-do (KR)

(21) Appl. No.: 14/922,068

(22) Filed: Oct. 23, 2015

Related U.S. Application Data
(60) Provisional application No. 62/068,546, filed on Oct. 24, 2014.

(30) Foreign Application Priority Data
Oct. 12, 2015 (KR) 10-2015-0142354

(51) Int. Cl. H04W 92/02

(52) U.S. Cl. CPC H04W 92/02

(57) ABSTRACT

A communication method and system for converging a 5G communication system for supporting higher data rates beyond a 4G system with a technology for Internet of Things (IoT). The present disclosure may be applied to intelligent services based on the 5G communication technology and the IoT-related technology, such as smart home, smart building, smart city, smart car, health care, digital education, smart retail, security and safety services. If a terminal in an idle state camps in a suitable cell, the terminal performs interworking between a mobile communication network and a wireless LAN by applying a network interworking parameter received from a base station. If the terminal is in a state of not camping in the suitable cell due to a temporal movement to be out of an area of the base station, the terminal does not use a function of interworking between the mobile communication network and the wireless LAN.

### CROSS-REFERENCE TO RELATED APPLICATIONS AND CLAIM OF PRIORITY

The present application is related to and claims benefit under 35 U.S.C. §119(e) of a U.S. Provisional application filed on Oct. 24, 2014 in the U.S. Patent and Trademark Office and assigned Ser. No. 62/068,546, and under 35 U.S.C. §119(a) of a Korean patent application filed on Oct. 12, 2015 in the Korean Intellectual Property Office and assigned Serial No. 10-2015-0142354, the entire disclosure of each of which is hereby incorporated by reference.

### TECHNICAL FIELD

The present disclosure relates to a wireless communication system, and more particularly, to a method and an apparatus for interworking between a terminal and a network when network interworking with a wireless LAN is supported.

### BACKGROUND

Recently, a wireless communication technology has been rapidly developed, and in line with this, a communication system technology has also evolved. Among the communication system technologies, a system, which is currently in the spotlight as the 4G mobile communication technology, is the Long-Term Evolution (LTE) system standardized by the 3rd Generation Partnership Project (3GPP) standard group. Further, it is common to mount a heterogeneous technology, such as a wireless LAN, to a terminal according to the increased use of smart phones, and a user may use an LTE network or a wireless LAN for communication as necessary.

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

### SUMMARY

To address the above-discussed deficiencies, it is a primary object to provide a method of performing network interworking by efficiently applying network interworking related information if a wireless LAN and an LTE network interwork in a wireless mobile communication system.

In accordance with an aspect of the present disclosure, a communication method of a terminal in a wireless communication system is provided. The method includes receiving, by the terminal, a first message containing a network interworking related parameter during a first state, if a state of the terminal is changed to a second state and returns to the first state again, identifying whether the first message received during the previous first state is effective, and if the first message received in the previous first state is effective, determining to use the network interworking related parameter for network interworking.

In accordance with another aspect of the present disclosure, terminal is provided. The terminal includes a transceiver configured to transceive a signal, and a controller configured to control the terminal to receive a first message containing including a network interworking related parameter during a first state, to identify whether the first message received in the previous first state is effective if a state of the terminal changes to a second state and returns to the first state again, and to determine to use the network interworking related parameter for network interworking if the first message received during the previous first state is effective.

According to the present technology, it is possible to prevent a UE from unnecessarily moving (ping-pong effect) between a wireless LAN and an LTE network, and to prevent the UE from unnecessarily receiving network interworking related information from a base station, thereby reducing power consumption.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features, and advantages of the present disclosure will be more apparent from the following detailed description in conjunction with the accompanying drawings, in which: For a more complete understanding of the present disclosure and its advantages, reference is now made to the following description taken in conjunction with the accompanying drawings, in which like reference numerals represent like parts:

FIG. 1 is a diagram schematically illustrating a structure of an LTE system, which is an example of a mobile communication network suggested in the present disclosure;

FIG. 2 is a diagram illustrating a wireless protocol structure of an LTE system, which is an example of a mobile communication network suggested in the present disclosure;

FIG. 3 is a diagram illustrating a message flow for interworking between a mobile communication network and a wireless LAN;

FIG. 4 is a diagram illustrating a message flow for interworking between a mobile communication network and a wireless LAN according to an exemplary embodiment of the present disclosure;

FIG. 5 is a diagram illustrating an operation of user equipment for interworking between a mobile communication network and a wireless LAN according to the exemplary embodiment of the present disclosure;

FIG. 6 is a diagram illustrating a schematic structure of user equipment according to the exemplary embodiment of the present disclosure; and

FIG. 7 is a diagram illustrating a schematic structure of a base station according to the exemplary embodiment of the present disclosure.

### DETAILED DESCRIPTION

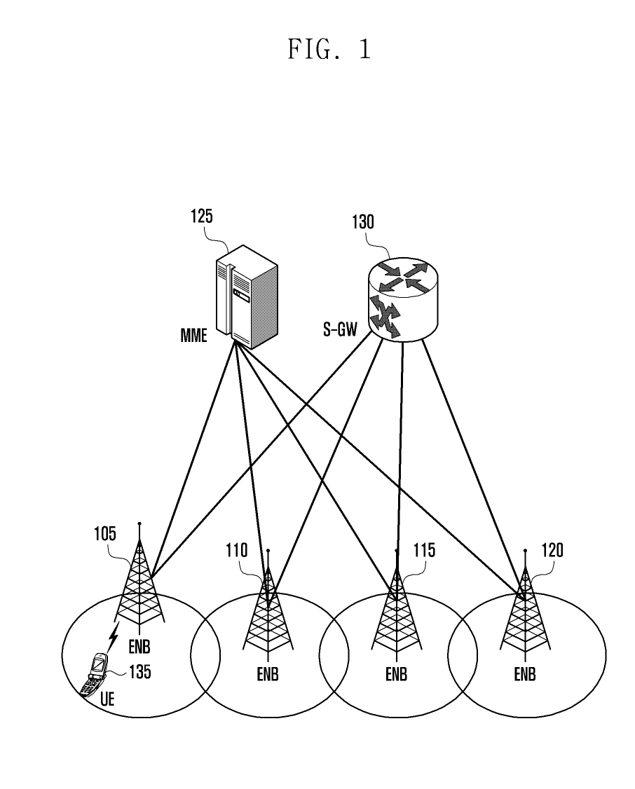

FIGS. 1 through 7, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged telecommunication technologies. Hereinafter, the present disclosure will be described with reference to the accompanying drawings. The present disclosure may have various embodiments, and modifications and changes may be made therein. Therefore, the present disclosure will be described in conjunction with particular embodiments shown in the accompanying drawings. However, it should be understood that the present disclosure is not limited to the particular embodiments, but includes all modifications, equivalents, and/or alternatives within the spirit and scope of the present disclosure. In describing the drawings, similar reference numerals are used to designate similar elements.

In the present disclosure, the expression “include” or “may include” refers to existence of a corresponding function, operation, or element, and does not limit one or more additional functions, operations, or elements. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof.

In the present disclosure, the expression “or” includes any or all combinations of words enumerated together. For example, the expression “A or B” may include A, may include B, or may include both A and B.

In the present disclosure, expressions including ordinal numbers, such as “first” and “second,” etc., may modify various elements. However, such elements are not limited by the above expressions. For example, the above expressions do not limit the sequence and/or importance of the elements. The above expressions are used merely for the purpose of distinguishing an element from the other elements. For example, a first user device and a second user device indicate different user devices although both of them are user devices. For example, a first element could be termed a second element, and similarly, a second element could be also termed a first element without departing from the scope of the present disclosure.

In the case where an element is referred to as being “connected” or “accessed” to other elements, it should be understood that not only the element is directly connected or accessed to the other elements, but also another element may exist between them. Contrarily, when an element is referred to as being “directly coupled” or “directly connected” to any other element, it should be understood that no element is interposed therebetween.

In the present disclosure, the terms are used to describe specific embodiments, and are not intended to limit the present disclosure. As used herein, the singular forms are intended to include the plural forms as well, unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present specification.

A mobile communication network of the present specification can include, for example, a 3GPP network, such as an LTE system. Exemplary embodiments of the present disclosure will be described in detail mainly based on the LTE system, but the main point of the present disclosure is also applicable to other mobile communication systems that have similar technical backgrounds and channel form with a slight modification without considerably departing from the scope of the present disclosure, and can be determined by those skilled in the art.

Hereinafter, a base station can be at least one of an eNode B (eNB), a node B, a base station (BS), a wireless access unit, a base station controller, and a node on a network. A terminal can include User Equipment (UE), a Mobile Station (MS), a cellular phone, a smart phone, a computer, or a multimedia system capable of performing a communication function.

FIG. 1 is a diagram schematically illustrating a structure of an LTE system.

Referring to FIG. 1, a wireless access network of the LTE system includes base stations (ENB) 105, 110, 115, and 120, a Mobility Management Entity (MME) 125, and a Serving-Gateway (S-GW) 130. The UE 135 accesses an external network through the ENBs 105, 110, 115, and 120 and the S-GW 130.

One ENB 105, 110, 115, or 120 generally controls a plurality of cells. In order to implement a transmission rate of 100 Mbps, the LTE system uses an Orthogonal Frequency Division Multiplexing (OFDM) scheme as a wireless access technology in a bandwidth of 20 MHz. Further, the ENBs 105, 110, 115, and 120 use an Adaptive Modulation & Coding (AMC) scheme, which determines a modulation scheme and a channel coding rate in accordance with a channel state of the UE 135.

The S-GW 130 is a device for providing a data bearer, and generates or removes the data bearer under the control of the MME 125. The MME 125 is a device serving various control functions, as well as a mobility management function for the UE 135, and is connected with a plurality of base stations.

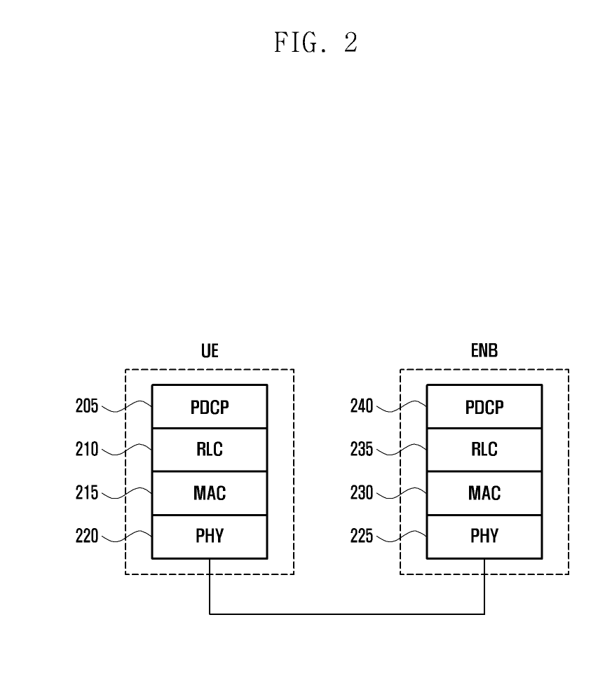

FIG. 2 is a diagram illustrating a structure of a wireless protocol in the LTE system.

Referring to FIG. 2, the UE and the ENB includes a Packet Data Convergence Protocol (PDCP) 205 and 240, a Radio Link Control (RLC) 210 and 235, a Medium Access Control (MAC) 215 and 230, respectively, as the wireless protocol of the LTE system.

The PDCP 205 and 240 serves to compress/restore an IP header and the like, and the RLC 210 and 235 re-configures a PDCP Packet Data Unit (PDU) in an appropriate size and serves an ARQ operation and the like. The MAC 215 and 230 is connected with various RLC layer devices configured in one UE, and performs a multiplexing of RLC PDUs to MAC PDU and a demultiplexing of the RLC PDUs from the MAC PDU. The PHY layers 220 and 225 perform an operation of channel-coding and modulating higher layer data, generating an OFDM symbol and transmitting the OFDM symbol through a radio channel, or demodulating and channel-decoding the OFDM symbol received through the radio channel and transmitting the demodulated and channel-decoded OFDM symbol to the higher layer.

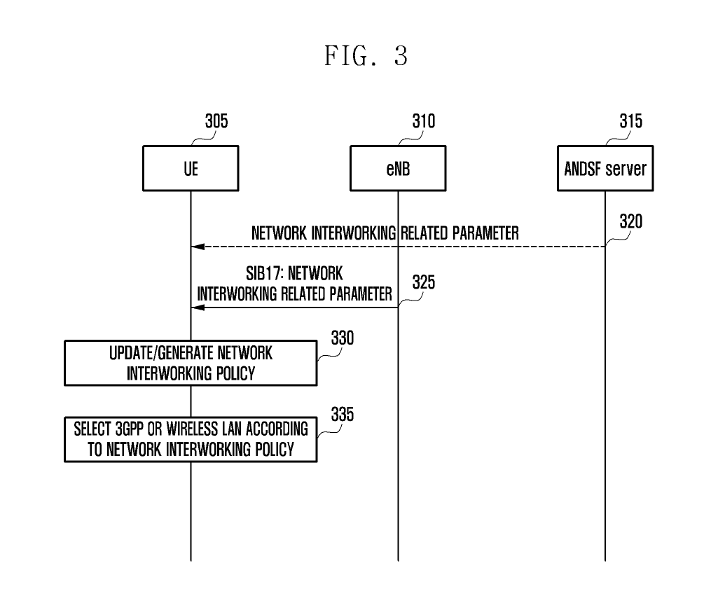

FIG. 3 is a diagram illustrating an example of a message flow for interworking between a mobile communication network (for example, an LTE network) and a wireless LAN.

In operation 320, a UE 305 that is connected to a mobile communication network can selectively receive a network interworking related parameter from an Access Network Discovery & Selection Function (ANDSF) server 315. The network interworking related parameter can include a network selection and traffic control related policy. The network interworking related parameter can include, for example, wireless LAN access point identifier information about a specific business operator, a corresponding wireless LAN access point connection related condition, and the like.

In operation 325, the UE 305 can additionally receive the network interworking related parameter from the base station 310 later. The UE 305 can receive the network interworking related parameter through a message, which a base station 310 transmits to all of the UEs within the cell through a broadcast, and can also receive the network interworking related parameter through a message (for example, a Radio Resource Control (RRC) connection resetting message), which a base station 310 transmits to a specific UE through a unicast.

The message transmitted through the broadcast can include a SystemInformationBlockType17 (SIB17) message. FIG. 3 illustrates a case where the network interworking related parameter is received through the broadcasted SIB17 message, but the present disclosure is not limited thereto, and the network interworking related parameter can also be received through a setting message transmitted through the unicast as a matter of course.

In operation 330, when the UE 305 has a policy previously received from the ANDSF server 315 and additionally receives the SIB17 message (or the setting message), the network interworking policy is updated by replacing replaceable items in the previously received policy with information on the SIB17 message (or the setting message). For example, when the ANDSF server 315 directs the UE to move to the wireless LAN when the signal intensity of the base station is X or lower, but the base station 310 transmits Y as a corresponding value, the UE 305 can update the policy so that the UE 305 moves to the wireless LAN when the signal intensity of the base station is Y or lower.

When the UE 305 does not have a policy previously received from the ANDSF server 315 or the UE 305 is not supported to receive the policy from the ANDSF server 315, the UE 305 can also generate a policy only with the network interworking related parameter transmitted by the base station 310. For example, when the base station 310 transmits Y as a value of a parameter related to the signal intensity of the base station, the UE 305 can generate a policy so that the UE 305 moves to the wireless LAN when the signal intensity of the base station is Y or lower.

In operation 335, the UE 305 can perform interworking between the mobile communication network and the wireless LAN with the updated or generated network interworking policy. The UE 305 can select the mobile communication network or the wireless LAN based on the network interworking policy.

In the meantime, when the UE 305 performs interworking with the wireless LAN based on the aforementioned procedure, a case where the UE moves to a shadow area and the like needs to be additionally considered. For example, when the UE moves the shadow area, the UE needs to clearly determine an operation for whether to perform the network interworking and whether to utilize information on the network interworking related parameter.

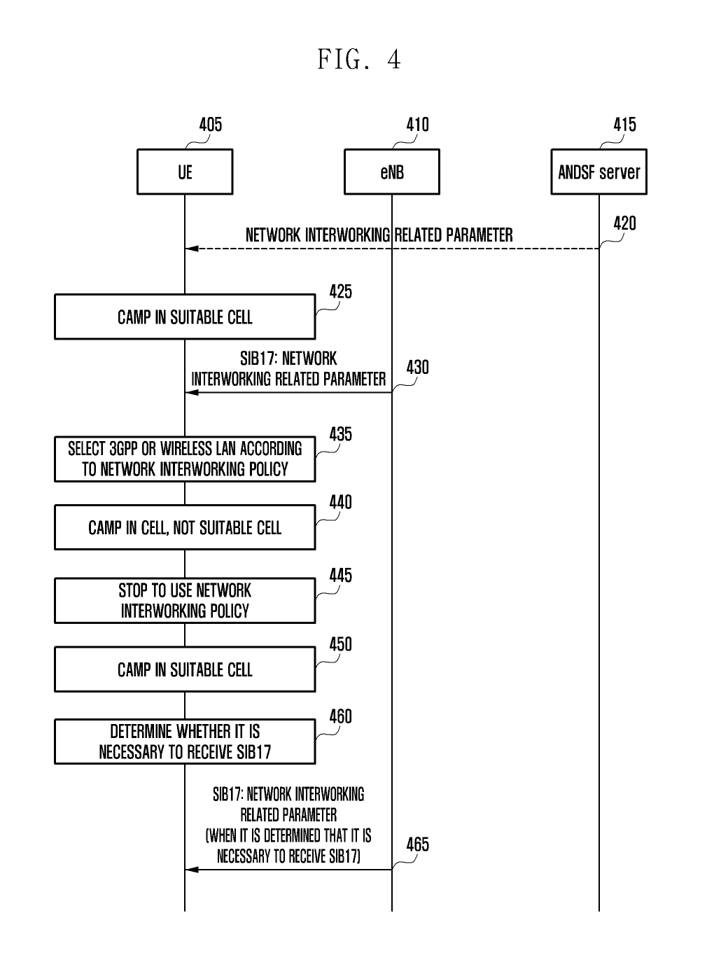

FIG. 4 is a diagram illustrating a message flow for interworking between a mobile communication network and a wireless LAN according to an exemplary embodiment of the present disclosure.

In operation 420, a UE 405 that is connected to a mobile communication network can selectively receive a network interworking related parameter from an Access Network Discovery & Selection Function (ANDSF) server 415. The network interworking related parameter can include a network selection and traffic control related policy. The network interworking related parameter can include, for example, wireless LAN access point identifier information about a specific business operator, a corresponding wireless LAN access point connection related condition, and the like.

In operation 415, when there is no traffic, the UE 405 receives a release command from a base station 410 and is operated in an idle mode, and the UE 405 selects a surrounding suitable cell by performing a cell selection or cell re-selection procedure and stays in the selected cell during the idle mode. The stay operation is also expressed as “camping”. The “suitable cell” can include a cell that satisfies at least one of the conditions below.
The UE can provide a normal service.
The cell is operated by a selected business operator/registered business operator/equivalent business operator.
For a CSG cell, the CSG cell exists in broadcasted CSG ID and CSG white list.
A cell is not blocked, and satisfies a cell selection condition.

According to the exemplary embodiment of the present disclosure, when the UE 405 camps in the cell satisfying the condition, the UE 405 can additionally receive the network interworking related parameter from the base station 410 in operation 430.

The UE 405 can receive the network interworking related parameter through a message, which the base station 410 transmits to all of the UEs within the cell through a broadcast, and can also receive the network interworking related parameter through a message (for example, an RRC connection resetting message), which the base station 410 transmits to specific UE through a unicast.

The message transmitted through the broadcast can include SystemInformationBlockType17 (SIB17) message. FIG. 4 illustrates a case where the network interworking related parameter is received through the broadcasted SIB17 message, but the present disclosure is not limited thereto, and the network interworking related parameter can also be received through a setting message that is transmitted through the unicast as a matter of course.

Although not illustrated in FIG. 4, when the UE 405 has a policy previously received from the ANDSF server 415 and additionally receives the SIB17 message (or the setting message), the network interworking policy can be updated by replacing replaceable items in the previously received policy with information on the SIB17 message (or the setting message). For example, when the ANDSF server 415 directs the UE 405 to move the wireless LAN when the signal intensity of the base station is X or lower, but the base station 410 transmits Y as a corresponding value, the UE 405 can update the policy so that the UE 405 moves to the wireless LAN when the signal intensity of the base station is Y or lower.

When the UE 405 does not have a policy previously received from the ANDSF server 415 or it is not supported that the UE 405 receives the policy from the ANDSF server 415, the UE 405 can also generate a policy only with the network interworking related parameter transmitted by the base station 410. For example, when the base station 410 transmits a value Y of parameter related to the signal intensity of the base station, the UE 405 can generate a policy so that the UE 405 moves to the wireless LAN when the signal intensity of the base station is Y or lower.

In operation 435, the UE 405 can perform interworking between the mobile communication network and the wireless LAN with the updated or generated network interworking policy. The UE 405 can select the mobile communication network or the wireless LAN based on the network interworking policy.

In operation 440, there can be a case where the UE 405 cannot find a “suitable cell” around the UE due to the movement to the shadow area and the like, so that the UE 405 cannot camp in the “suitable cell”. For example, a case where the UE 405 camps in a cell, not the “suitable cell”, can be included.

In operation 445, the UE 405 can stop the operation of performing interworking between the mobile communication network and the wireless LAN of operation 435 in this case. In this case, the UE 405 can continuously store the network interworking related parameter previously received from the base station 410.

Then, in operation 450, the UE 405 can search for a “suitable cell” in the surrounding area again and can camp in the corresponding cell. That is, the UE 405 can be in a state of camping in the “suitable cell”.

In this case, in operation 460, the UE 405 can determine whether it is possible to use the previously received and stored network interworking related parameter as it is, or it is necessary to receive a new network interworking related parameter. FIG. 4 illustrates a case where the UE 405 determines whether it is necessary to receive the SIB17 message, but the present disclosure is not limited thereto. For example, when the “suitable cell” that is found again by the UE 405 is the same as the “suitable cell” in which the UE 405 last stays, the UE 405 can determine that it is not necessary to re-receive the network interworking related parameter. However, when the “suitable cell” that is found again by the UE 405 is not the same as the “suitable cell”, in which the UE 405 last stays, or when the corresponding parameter is changed during the search even though the “suitable cell” that is found again by the UE 405 is the same as the “suitable cell”, in which the UE 405 last stays, the UE 405 can determine that it is necessary to re-receive the network interworking related parameter. The UE 405 can determine whether the previously received network interworking related parameter is changed, for example, by checking the value of ValueTag transmitted through the SIB17 message and determining whether the value is changed.

In operation 465, when the UE 405 determines that it is necessary to receive a new network interworking related parameter, the UE 405 can receive a new network interworking related parameter from the base station 410 through the SIB17 message.

That is, according to the exemplary embodiment of the present disclosure, in a case where it is desired to interwork between the mobile communication network and the wireless LAN in the wireless mobile communication system, the UE can receive the network interworking related information as necessary and can perform network interworking only when the UE camps in the “suitable cell”. Further, when the UE does not camp in the “suitable cell”, the UE does not perform network interworking based on the network interworking related information and search for a “suitable cell”.

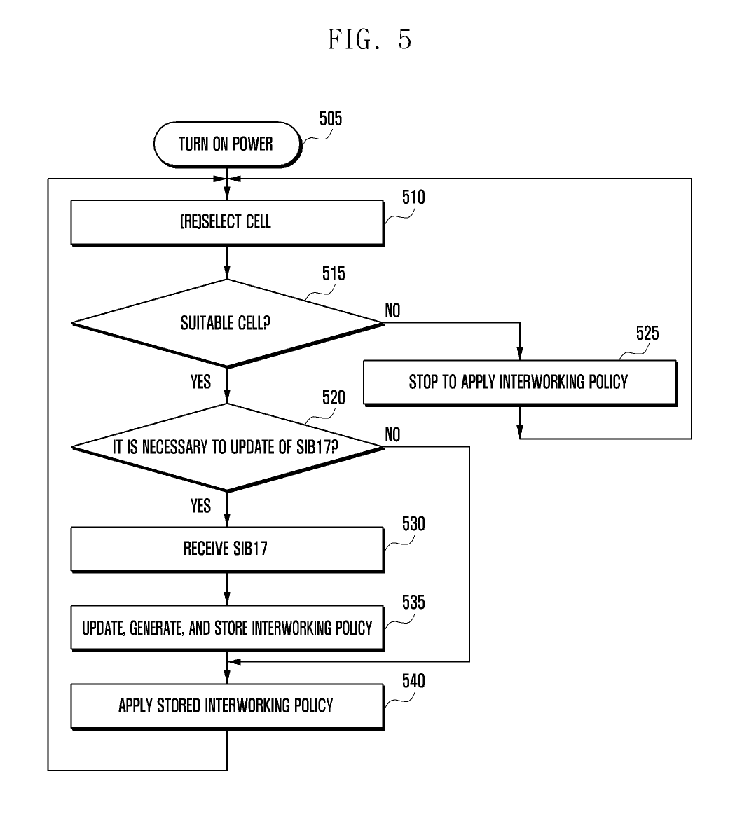

FIG. 5 is a diagram illustrating an operation of UE (for example, the UE 405) for interworking between a mobile communication network and a wireless LAN according to the exemplary embodiment of the present disclosure.

In operation 505, a UE can turn on power, and in operation 510, the UE can camp in a cell that is selected by performing a cell selection. For example, the UE can perform a cell selection procedure in order to search for a “suitable cell” in a surrounding area, and can continuously perform a cell reselection procedure in order to search for a better cell.

In operation 515, the UE can confirm whether the cell, in which the UE camps, is the “suitable cell”. For example, a state where the UE camps in the “suitable cell” can be defined as a first state, and a state where the UE deviates from the state where the UE camps in the “suitable cell”, for example, a state where the UE camps in an unsuitable cell, can be defined as a second state.

When it is confirmed that the UE camps in the “suitable cell, that is, the UE is in the first state, the UE can determine whether it is necessary to update the SIB17 message in operation 520. For example, when a state of the UE is changed from the first state to the second state, and then returns to the first state, the UE can determine whether it is necessary to update the SIB17 message. FIG. 5 illustrates a case where the SIB17 message is updated, but various exemplary embodiments of the present disclosure can include various examples of determining whether it is necessary to update the network interworking parameter. In a case where the UE has the SIB17 message received from the “suitable cell”, in which the UE previously camps, and stored, when the re-found “suitable cell” is the same as the “suitable cell”, in which the UE last stays, and the previously received and stored SIB17 message is not changed, the UE can determine that it is not necessary to update the SIB17 message. Otherwise, the UE can determine that it is necessary to update the SIB17 message. Whether the previously received SIB17 message is changed can be determined, for example, by checking a value of ValueTag transmitted through the SIB17 message and determining whether the value is changed.

When it is determined that it is necessary to update the SIB17 message, the UE can receive the SIB17 message currently transmitted through the “suitable cell” in operation 530.

In operation 535, when the UE has a network interworking policy that has been previously received from an ANDSF server and the like by accessing a base station and stored, and additionally receives the SIB17 message, the UE can update the network interworking policy by replacing replaceable items in the previously received policy with information on the SIB17 message. For example, when the ANDSF server directs the UE to move the wireless LAN when the signal intensity of the base station is X or lower, but the base station transmits Y as a corresponding value, the UE can update the policy so that the UE moves to the wireless LAN when the signal intensity of the base station is Y or lower.

Otherwise, when the UE does not have a policy previously received from the ANDSF server or it is not supported that the UE receives the network policy from the ANDSF server, the UE can also generate a policy only with the SIB17 message transmitted by the base station. For example, when the base station transmits Y as a value of a parameter related to the signal intensity of the base station, the UE can generate a policy so that the UE moves to the wireless LAN when the signal intensity of the base station is Y or lower. The UE can store the updated or generated network interworking policy.

In operation 540, the UE can perform interworking between the mobile communication network and the wireless LAN by applying the stored network interworking policy.

In the meantime, when it is not necessary to update the SIB17 message in operation 520, the UE can perform interworking between the mobile communication network and the wireless LAN by applying the previously received and stored network interworking policy.

Further, when the UE cannot find a “suitable cell” by performing the cell selection or cell re-selection procedure in operation 515, the UE can stop the operation of performing interworking between the mobile communication network and the wireless LAN with the aforementioned network interworking policy in operation 525. However, the UE can continuously store the network interworking related parameter previously received from the base station. Then, when the UE finds the “suitable cell” again, the UE can also continuously use the previously stored network interworking related parameter without re-reception according to necessity of the update.

Accordingly, according to various exemplary embodiments of the present disclosure, when the UE does not camp in the “suitable cell”, it is possible to prevent the UE from unnecessarily moving between the wireless LAN and the mobile communication network (a Ping-Pong effect). Further, when the UE has previously received the network interworking related information from the base station, the UE does not unnecessarily receive the network interworking related information from the base station when returning to the corresponding cell again, thereby decreasing power consumption.

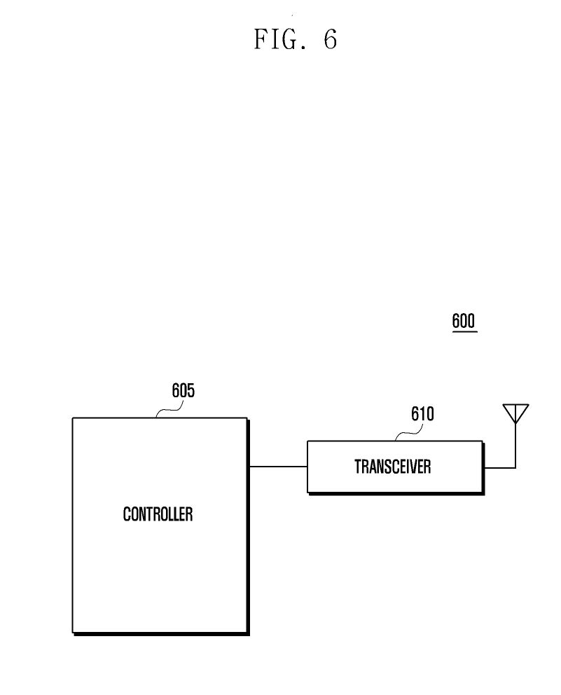

FIG. 6 is a diagram illustrating a schematic structure of a user equipment according to the exemplary embodiment of the present disclosure.

Referring to FIG. 6, a UE 600 can include a controller 605 and a transceiver 610.

The controller 605 can control an operation of the UE according to the aforementioned exemplary embodiment of the present disclosure to be implemented.

The transceiver 610 can transceive a signal with a base station or a network interworking server under the control of the controller 605.

For example, the controller 605 can control the UE to receive a first message that includes the network interworking related parameter in a first state. Then, when the state of the UE is changed to the second state and then returns to the first state, the controller 605 can determine whether the first message received in the previous first state is effective, and when the first message received in the previous first state is effective, the UE can determine to use the network interworking related parameter for network interworking.

For example, the first state can indicate that the UE camps in a cell, which satisfies a predetermined condition. Further, the second state can indicate that the UE camps in a cell, which does not satisfy the predetermined condition. In the state where the state of the UE returns to the first state can indicate that the UE camps in the same cell as the cell, in which the UE camps in the previous first state, again.

For example, the cell satisfying the predetermined condition is operated by a business operator to which the UE subscribes.

The first message can include a setting message transmitted by a base station or a system information message of system information block type 17 broadcasted by the base station.

For example, when the state of the UE changes to the second state and then returns to the first state, the controller 605 can control the EU to receive a second message containing information indicating whether to change a parameter included in the previously received system information message. Further, the controller 605 can confirm whether the previously received system information message is effective based on the information included in the second message. For example, the second message can include a system information message of system information block type 1 broadcasted by the base station.

In the meantime, the network interworking related parameter can include information for interworking with the wireless LAN. The information for interworking with the wireless LAN can include at least one of identification information about the wireless LAN and the wireless LAN access condition information.

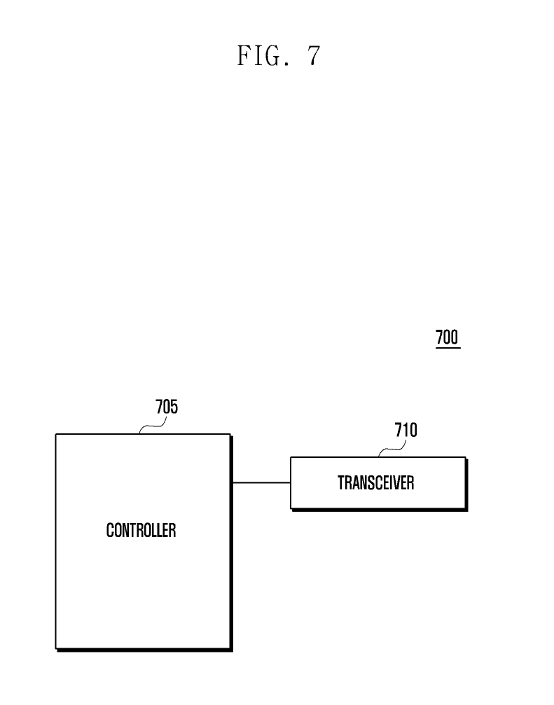

FIG. 7 is a diagram illustrating a schematic structure of a base station according to the exemplary embodiment of the present disclosure.

Referring to FIG. 7, a base station 700 can include a controller 705 and a transceiver 710.

The controller 705 can control an operation of the base station according to the exemplary embodiment of the present disclosure to be implemented.

The transceiver 710 can transceive a signal with a UE under the control of the controller 705.

For example, when the UE camps in a cell satisfying a predetermined condition, the controller 705 can control a first message containing a network interworking related parameter to be transmitted to the UE. The first message can include a setting message transmitted by unicast or a system information message of system information block type 17 broadcasted by the base station. For example, the cell, which satisfies the predetermined condition, is operated by a business operator to which the UE subscribes.

Further, when the UE deviates from the state where the UE camps in the cell satisfying the predetermined condition and then camps in a cell satisfying the predetermined condition again, the controller 705 can control a second message containing information indicating whether to change a parameter included in the previously received system information message to be transmitted. The second message can include a system information message of system information block type 1 broadcasted by the base station.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communication method of a terminal in a wireless communication system, comprising:
receiving, by the terminal, a first message containing a network interworking related parameter during a first state;
if a state of the terminal changes to a second state and returns to the first state again, identifying whether the first message received during the previous first state is effective; and
if the first message received during the previous first state is effective, determining to use the network interworking related parameter for network interworking.

2. The communication method of claim 1, wherein the first state indicates that the terminal camps in a cell, which satisfies a predetermined condition.

3. The communication method of claim 2, wherein the cell satisfying the predetermined condition is operated by a business operator to which the UE subscribes.

4. The communication method of claim 2, wherein the state of the terminal returns to the first state indicating that the terminal camps in the same cell as the cell, in which the terminal camps in the previous first state again.

5. The communication method of claim 2, wherein the second state indicates that the terminal camps in a cell, which does not satisfy a predetermined condition.

6. The communication method of claim 1, wherein the first message includes a setting message transmitted by a base station or a system information message of system information block type 17 broadcasted by the base station.

7. The communication method of claim 6, wherein identifying whether the first message received during the previous first state is effective includes:
if the state of the terminal changes the second state and then returns to the first state, receiving a second message including information indicating whether to change a parameter included in the previously received system information message; and
confirming whether the previously received system information message is effective based on the information included in the second message.

8. The communication method of claim 7, wherein the second message includes a system information message of system information block type 1 broadcasted by the base station.

9. The communication method of claim 1, wherein the network interworking related parameter contains information for interworking with a wireless LAN.

10. The communication method of claim 9, wherein the information for interworking with the wireless LAN contains at least one of identification information about the wireless LAN and the wireless LAN access condition information.

11. A terminal, comprising:
a transceiver configured to transceive a signal; and
a controller configured to:
control the transceiver to receive a first message containing including a network interworking related parameter during a first state;
identify whether the first message received in the previous first state is effective if a state of the terminal changes to a second state and returns to the first state again; and
determine to use the network interworking related parameter for network interworking if the first message received during the previous first state is effective.

12. The terminal of claim 11, wherein the first state indicates that the terminal camps in a cell, which satisfies a predetermined condition.

13. The terminal of claim 12, wherein the cell satisfying the predetermined condition is operated by a business operator to which the UE subscribes.

14. The terminal of claim 12, wherein the state of the terminal returning to the first state indicates that the terminal camps in the same cell as the cell in which the terminal re-camps in the previous first state.

15. The terminal of claim 12, wherein the second state indicates that the terminal camps in a cell, which does not satisfy a predetermined condition.

16. The terminal of claim 11, wherein the first message includes a setting message transmitted by a base station or a system information message of system information block type 17 broadcasted by the base station.

17. The terminal of claim 16, wherein the controller is configured to:
control the transceiver to receive a second message containing information indicating whether to change a parameter included in the previously received system information message if the state of the terminal changes to the second state and then returns to the first state, and
confirm whether the previously received system information message is effective based on the information included in the second message.

18. The terminal of claim 17, wherein the second message includes a system information message of system information block type 1 broadcasted by the base station.

19. The terminal of claim 11, wherein the network interworking related parameter includes information for interworking with a wireless LAN.

20. The terminal of claim 19, wherein the information for interworking with the wireless LAN includes at least one of identification information about the wireless LAN and the wireless LAN access condition information.
